(19) United States
(12) Patent Application Publication
(10) Pub. No.: US 2023/0182223 A1
(43) Pub. Date: Jun. 15, 2023

(54) BRAZING METHOD

(71) Applicant: HONDA MOTOR CO., LTD., Tokyo (JP)

(72) Inventor: Tsutomu YASUDA, Tokyo (JP)

(21) Appl. No.: 18/063,692

(22) Filed: Dec. 9, 2022

(30) Foreign Application Priority Data
Dec. 14, 2021 (JP) 2021202251
Jun. 15, 2022 (JP) 2022096223

(51) Int. Cl. B23K 1/19

(52) U.S. Cl. CPC B23K 1/19; B23K 2103/05

(57) ABSTRACT

A brazing method for brazing a first stainless steel base material that contains a metal that is more susceptible to oxidation than Cr and a second stainless steel base material that does not substantially contain the metal that is more susceptible to oxidation than Cr to each other is provided. Furthermore, a product containing a first stainless steel base material that contains a metal that is more susceptible to oxidation than Cr and a second stainless steel base material that does not substantially contain the metal that is more susceptible to oxidation than Cr, which are brazed to each other, is provided.

This application is based on and claims the benefit of priority from Japanese Patent Application Nos. 2021-202251 and 2022-096223, respectively filed on 14 Dec. 2021 and 15 Jun. 2022, the contents of which are incorporated herein by reference.

### BACKGROUND OF THE INVENTION

### Field of the Invention

The present invention relates to a brazing method.

### Related Art

Conventionally, brazing is carried out by melting a brazing material having a lower melting point than that of a base material and causing the melted brazing material to penetrate into a clearance for joining, as such a brazing technique results in very little melting of the base material and allows for precise joining and ease of mass production.

Herein it is noted that, since there are difficulties in brazing a ferrous sintered material to an aluminum casting product, such a method has been known that, after an indirect member, with which brazing to an aluminum casting product is easier, and a ferrous sintered material are joined to each other through friction pressure welding, the indirect member joined to the ferrous sintered material and an aluminum casting product are brazed to each other (see Japanese Unexamined Patent Application, Publication No. H7-32137).

On the other hand, brazing on stainless steel base materials has been performed when manufacturing components of automotive engines, such as fuel tubes, tubes for superchargers, and similar tubes, which require corrosion-resistant characteristics and sealing characteristics at joints.
Patent Document 1: Japanese Unexamined Patent Application, Publication No. H7-32137

### SUMMARY OF THE INVENTION

However, for stainless steel base materials containing Al, when brazing is performed on a stainless steel base material containing Al with a brazing material that is low in wettability, its brazing length becomes shorter.

An object of the present invention is to provide a brazing method that uses no indirect member, but that makes it possible to lengthen a brazing length when brazing is performed on a stainless steel base material with a brazing material that is low in wettability.

An aspect of the present invention is directed to a brazing method with which a first stainless steel base material that contains a metal that is more susceptible to oxidation than Cr and a second stainless steel that does not substantially contain the metal that is more susceptible to oxidation than Cr are brazed to each other.

The metal that is more susceptible to oxidation than Cr may be one or more selected from the group consisting of Ti, Al, and Nb.

In the brazing method described above, a clearance in a joining region between the first stainless steel base material and the second stainless steel base material may be equal to or less than 0.4 mm.

Another aspect of the present invention is directed to a product in which a first stainless steel base material that contains a metal that is more susceptible to oxidation than Cr and a second stainless steel that does not substantially contain the metal that is more susceptible to oxidation than Cr are brazed to each other.

According to the present invention, it is possible to provide a brazing method that uses no indirect member, but that makes it possible to lengthen a brazing length when brazing is performed on a stainless steel base material with a brazing material that is low in wettability.

### BRIEF DESCRIPTION OF THE DRAWINGS

FIG. 1 is a graph illustrating equilibrium temperatures between metals and metallic oxides in a hydrogen atmosphere;

FIGS. 2A and 2B are perspective views illustrating an example of a brazing method according to an embodiment;

FIG. 3 is a perspective view illustrating a test piece for brazing, which was used in examples;

FIG. 4 is a graph illustrating a relationship of brazing length with respect to each of clearances in test pieces for brazing according to Examples 1-1 to 1-6 and Comparative Examples 1-1 to 1-6;

FIG. 5 is a graph illustrating a relationship of brazing length with respect to each of clearances in test pieces for brazing according to Examples 2-1 to 2-6 and Comparative Examples 2-1 to 2-6;

FIG. 6 is a graph illustrating a relationship of brazing length with respect to each of clearances in test pieces for brazing according to Examples 3-1 to 3-6 and Comparative Examples 3-1 to 3-6;

FIG. 7 is a graph illustrating a relationship of brazing strength with respect to each of clearances in test pieces for brazing according to Examples 1-1 to 1-4;

FIG. 8 is a graph illustrating a relationship of brazing strength with respect to each of clearances in test pieces for brazing according to Examples 2-1 to 2-4; and

FIG. 9 is a graph illustrating a relationship of brazing strength with respect to each of clearances in test pieces for brazing according to Examples 3-1 to 3-4.

### DETAILED DESCRIPTION OF THE INVENTION

An embodiment of the present invention will now be described herein with reference to the accompanying drawings.

### [Brazing Method]

In a brazing method according to the present embodiment, a first stainless steel base material that contains a metal that is more susceptible to oxidation than Cr and a second stainless steel base material that does not substantially contain a metal that is more susceptible to oxidation than Cr are brazed to each other.

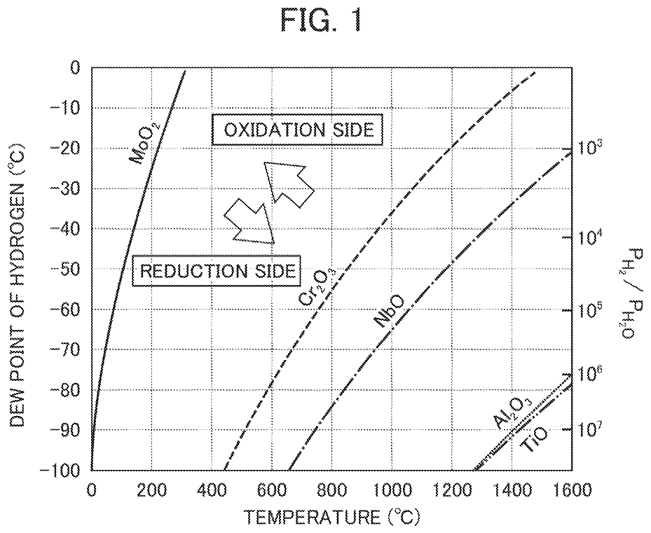

In the present specification and the claims, a metal that is more susceptible to oxidation than Cr means a metal in which an equilibrium temperature between a metal and a metallic oxide in a hydrogen atmosphere is higher than an equilibrium temperature between chromium and a chromium oxide (III) (see FIG. 1). Furthermore, the term “that does not substantially contain” means not contained in an amount exceeding the range of unavoidable mixed impurities, i.e., not intentionally added.

A film (a passivation film) of a metallic oxide containing chromium oxide (III) normally forms on the surface of a stainless steel base material. Note herein that, since a passivation film lowers the wettability of a brazing material, such a passivation film is reduced when brazing is performed on a stainless steel base material. At this time, due to the point that, in a stainless steel base material that contains a metal that is more susceptible to oxidation than Cr, there are difficulties in fully reducing a passivation film, the wettability of a brazing material lowers.

Since, in the present embodiment, a first stainless steel base material that contains a metal that is more susceptible to oxidation than Cr and a second stainless steel base material that does not substantially contain a metal that is more susceptible to oxidation than Cr are brazed to each other, it is possible to complement the wettability of a brazing material on the first stainless steel base material with the wettability of the brazing material on the second stainless steel base material, resulting in an increase in brazing length.

The metal that is more susceptible to oxidation than Cr and that is contained in the first stainless steel base material is not particularly limited, but may be, for example, Ti, Al, Nb, etc. Two or more of these may be used in combination.

A content of a metal that is more susceptible to oxidation than Cr and that is contained in the first stainless steel base material is not particularly limited, but may be, for example, equal to or greater than 0.05% by mass.

The metallic structure of the first stainless steel base material is not particularly limited, but may be, for example, austenitic, ferritic, martensitic, austenitic-ferritic duplex, etc.

The first stainless steel base material may further contain Ni, Cu, and other substances, in addition to Fe, Cr, and metals that are more susceptible to oxidation than Cr.

Examples of the first stainless steel include SUS304N2, SUS321, SUS347, SUS430LX, SUS430J1L, SUS436L, SUS436J1L, SUS444, SUS631, and SUS631J1.

The shape of the first stainless steel base material is not particularly limited, but may be, for example, a plate shape, a tubular shape, etc.

The metallic structure of the second stainless steel base material is not particularly limited, but may be, for example, ferritic, austenitic, etc.

The second stainless steel base material may further contain C, Mo, Ni, Si, and other substances, in addition to Fe and Cr.

Examples of the second stainless steel include SUS304, SUS304L, SUS309S, SUS3103, SUS316, SUS316L, and SUS430.

The shape of the second stainless steel base material is not particularly limited, but may be, for example, a plate shape, a tubular shape, etc.

The brazing material is not particularly limited, but may be, for example, a copper brazing material, etc.

The shape of the brazing material is not particularly limited, but may be, for example, a bar shape, etc.

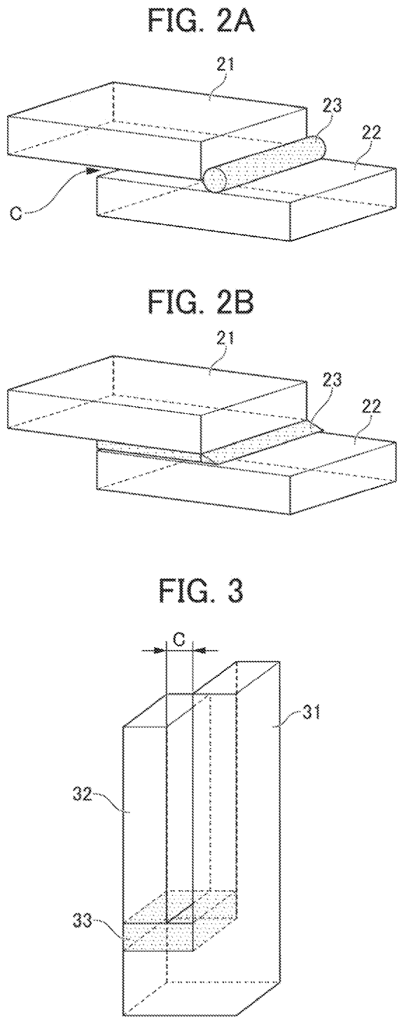

FIGS. 2A and 2B illustrate an example of the brazing method according to the present embodiment.

After jigs are first used to dispose a first stainless steel plate 21 and a second stainless steel plate 22, between which a joining region spans at a predetermined clearance C, a brazing material 23 having a bar shape is disposed adjacent to the joining region between the first stainless steel plate 21 and the second stainless steel plate 22 (see FIG. 2A). Next, as heating is performed at a temperature that is equal to or higher than a melting point of the brazing material 23 and that is equal to or lower than melting points of the first stainless steel plate 21 and the second stainless steel plate 22 under a hydrogen atmosphere, passivation films formed on the surfaces of the first stainless steel plate 21 and the second stainless steel plate 22 are reduced, and, at the same time, the brazing material 23 is melted. At this time, for the second stainless steel plate 22, due to the higher wettability of the brazing material 23, the brazing material 23 penetrates into the clearance C (see FIG. 2B). Next, as cooling is performed to a temperature that is equal to or lower than the melting point of the brazing material 23, the brazing material 23 penetrated into the clearance C solidifies, joining the first stainless steel plate 21 and the second stainless steel plate 22 to each other.

The clearance C in the joining region between the first stainless steel plate 21 and the second stainless steel plate 22 is preferably equal to or less than 0.4 mm and more preferably equal to or less than 0.3 mm. When C is equal to or less than 0.4 mm, the brazing length becomes longer. Note that C is not particularly limited, but may be, for example, equal to or greater than 0.1 mm.

The dew point of hydrogen is not particularly limited, but may be, for example, equal to or higher than −70° C. and equal to or lower than −30° C. The temperature at which heating is performed under the hydrogen atmosphere is not particularly limited, but may be, for example, equal to or higher than 900° C. and equal to or lower than 1200° C. The period of time during which heating is performed under the hydrogen atmosphere is not particularly limited, but may be, for example, equal to or greater than 0.5 minutes and equal to or less than 10 minutes.

Note that the heating method in the brazing method according to the present embodiment is not particularly limited.

### [Product]

In a product according to the present embodiment, a first stainless steel base material and a second stainless steel base material are brazed to each other. Note herein that, in the product according to the present embodiment, brazing is performed with the brazing method according to the present embodiment.

Specific examples of the product according to the present embodiment include, but are not particularly limited to, components of automotive engines, such as fuel tubes including fuel pipes and fuel joint pipes and tubes for superchargers including water pipes and oil pipes.

The embodiment of the present invention has been described above. However, the present invention is not limited to the embodiment described above. The embodiment described above may be modified appropriately within the scope of the present invention.

### EXAMPLES

Examples of the present invention will now be described below. However, the present invention is not limited to the examples.

### Examples 1-1 to 1-6

Jigs were used to dispose a first stainless steel (SUS321) plate 31 added with Ti at 0.4V by mass and having an L shape, a second stainless steel (SUS304) plate 32, and a brazing material (BCu-1) 33 having a melting point of 1083° C. and a rectangular shape, as illustrated in FIG. 3, to acquire test pieces for brazing.

Note herein that the clearances C in the test pieces for brazing were set to 0.1 mm (Example 1-1), 0.2 mm, (Example 1-2), 0.3 mm (Example 1-3), 0.4 mm (Example 1-4), 0.5 mm (Example 1-5), and 0.6 mm (Example 1-6).

Furthermore, in the joining regions of the test pieces for brazing, the shapes of the first stainless steel plate 31 and the second stainless steel plate 32 are each, when viewed in a top view, a rectangular shape having a size of 10 mm in vertical directions by 5 mm in horizontal directions.

Next, after the test pieces for brazing were each heated at 1130° C. for 60 seconds under a hydrogen atmosphere at a dew point of −40° C., the test pieces for brazing were cooled to room temperature. The first stainless steel plate 31 and the second stainless steel plate 32 were thus brazed to each other.

### Comparative Examples 1-1 to 1-6

A plate made of SUS321 was used as the second stainless steel plate 32, and, similar to Examples 1-1 to 1-6, excluding that each of test pieces for brazing was heated at 1150° C. under a hydrogen atmosphere at a dew point of −55° C., the first stainless steel plate 31 and the second stainless steel plate 32 were brazed to each other.

### [Brazing Length]

The joint on each of the test pieces for brazing after being brazed was visually checked to measure the brazing length.

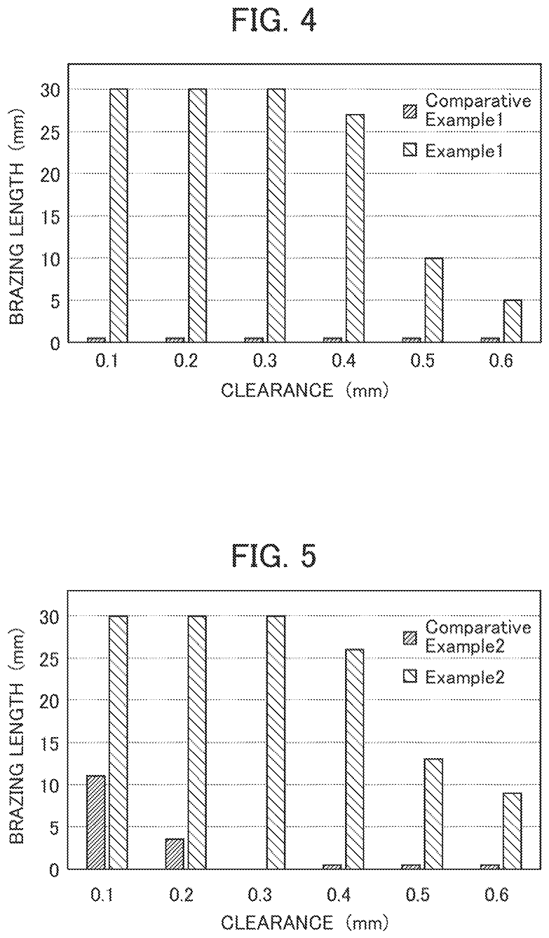

FIG. 4 illustrates a relationship of brazing length with respect to each of the clearances in the test pieces for brazing according to Examples 1-1 to 1-6 and Comparative Examples 1-1 to 1-6.

From FIG. 4, it can be seen that the test pieces for brazing according to Examples 1-1 to 1-6 each have a longer brazing length, compared with the test pieces for brazing according to Comparative Examples 1-1 to 1-6.

Next, test pieces acquired by cutting the test pieces for brazing according to Examples 1-1 to 1-4 after being brazed at the respective joints to a thickness of 4 mm were used to measure, with a material strength tester, the brazing strength (the tensile strength and the shear strength).

FIG. 7 illustrates a relationship of the brazing strength with respect to each of the clearances in the test pieces for brazing according to Examples 1-1 to 1-4.

### Examples 2-1 to 2-6

Similar to Examples 1-1 to 1-6, respectively, except that a stainless steel plate in which Al was added at 0.4% by mass was used as the first stainless steel plate 31, the first stainless steel plate 31 and the second stainless steel plate 32 were brazed to each other.

### Comparative Examples 2-1 to 2-6

Similar to Examples 2-1 to 2-6, respectively, except that a stainless steel plate in which Al was added at 0.4% by mass was used as the second stainless steel plate 32 and each of test pieces for brazing was heated at 1150° C. under a hydrogen atmosphere at a dew point of −55° C., the first stainless steel plate 31 and the second stainless steel plate 32 were brazed to each other.

FIG. 5 illustrates a relationship of brazing length with respect to each of the clearances in the test pieces for brazing according to Examples 2-1 to 2-6 and Comparative Examples 2-1 to 2-6.

From FIG. 5, it can be seen that the test pieces for brazing according to Examples 2-1 to 2-6 each have a longer brazing length, compared with the test pieces for brazing according to Comparative Examples 2-1 to 2-6.

Next, test pieces acquired by cutting the test pieces for brazing according to Examples 2-1 to 2-4 after being brazed at the respective joints to a thickness of 4 mm were used to measure, with a material strength tester, the brazing strength (the tensile strength and the shear strength).

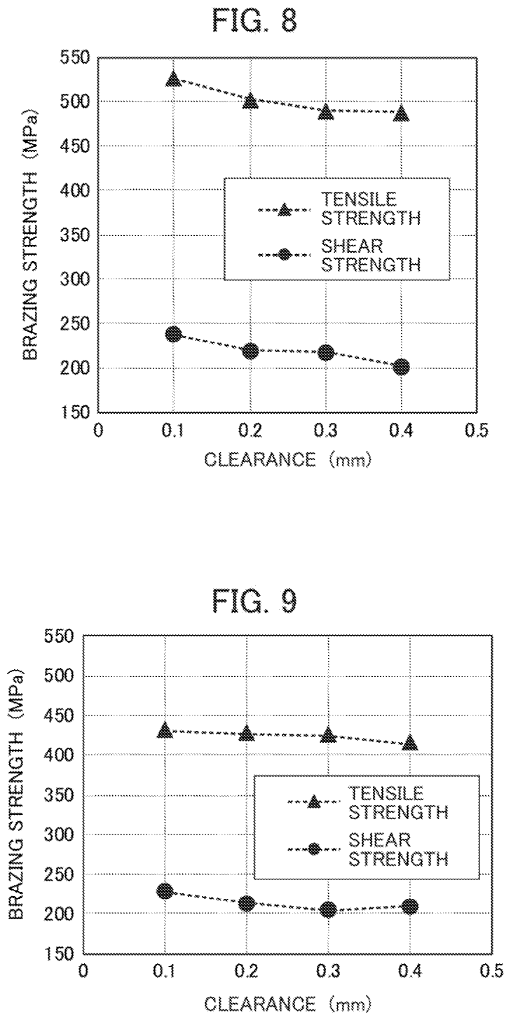

FIG. 8 illustrates a relationship of the brazing strength with respect to each of the clearances in the test pieces for brazing according to Examples 2-1 to 2-4.

### Examples 3-1 to 3-6

Similar to Examples 1-1 to 1-6, respectively, except that a plate made of SUS430LX in which Nb was added at 0.3% by mass was used as the first stainless steel plate 31 and a plate made of SUS430 was used as the second stainless steel plate 32, and each of the test pieces for brazing was heated at 1100° C., the first stainless steel plate 31 and the second stainless steel plate 32 were brazed to each other.

### Comparative Examples 3-1 to 3-6

Similar to Examples 3-1 to 3-6, respectively, except that a plate made of SUS430LX was used as the second stainless steel plate 32, the first stainless steel plate 31 and the second stainless steel plate 32 were brazed to each other.

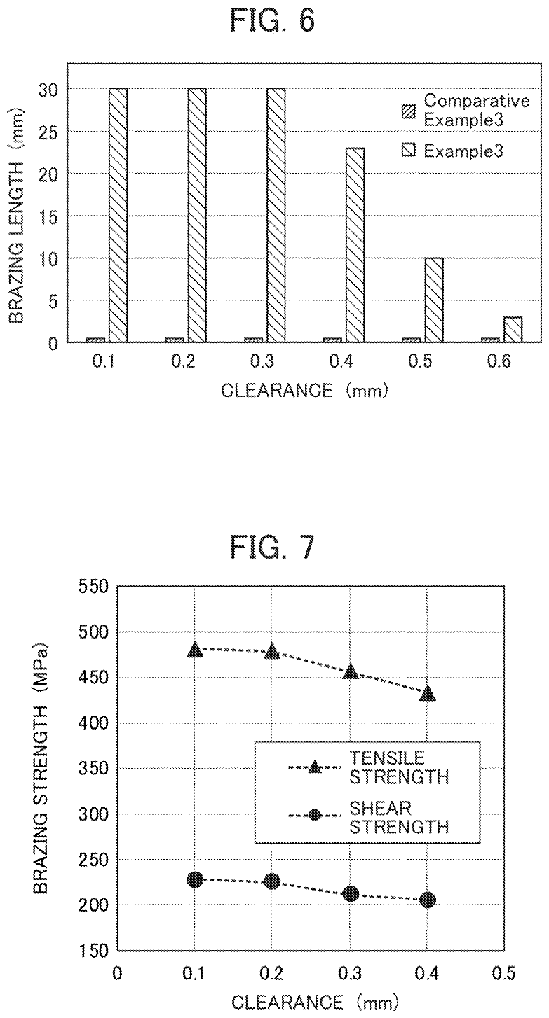

FIG. 6 illustrates a relationship of brazing length with respect to each of the clearances in the test pieces for brazing according to Examples 3-1 to 3-6 and Comparative Examples 3-1 to 3-6.

From FIG. 6, it can be seen that the test pieces for brazing according to Examples 3-1 to 3-6 each have a longer brazing length, compared with the test pieces for brazing according to Comparative Examples 3-1 to 3-6.

Next, test pieces acquired by cutting the test pieces for brazing according to Examples 3-1 to 3-4 after being brazed at the respective joints to a thickness of 4 mm were used to measure, with a material strength tester, the brazing strength (the tensile strength and the shear strength).

FIG. 9 illustrates a relationship of the brazing strength with respect to each of the clearances in the test pieces for brazing according to Examples 3-1 to 3-4 after being brazed.

### EXPLANATION OF REFERENCE NUMERALS

21, 31 First stainless steel plate
22, 32 Second stainless steel plate
23, 33 Brazing material

What is claimed is:

1. A brazing method, the method comprising brazing a first stainless steel base material that contains a metal that is more susceptible to oxidation than Cr and a second stainless steel base material that does not substantially contain the metal that is more susceptible to oxidation than Cr to each other.

2. The brazing method according to claim 1, wherein the metal that is more susceptible to oxidation than Cr is one or more selected from the group consisting of Ti, Al, and Nb.

3. The brazing method according to claim 1, wherein a clearance in a joining region between the first stainless steel base material and the second stainless steel base material is equal to or less than 0.4 mm.

4. A product comprising a first stainless steel base material that contains a metal that is more susceptible to oxidation than Cr and a second stainless steel base material that does not substantially contain the metal that is more susceptible to oxidation than Cr, the first stainless steel base material and the second stainless steel base material being brazed to each other.
